(19) United States
(12) Patent Application Publication
(10) Pub. No.: US 2006/0131265 A1
(43) Pub. Date: Jun. 22, 2006

(54) Method of forming branched structures

(76) Inventors: Victor Donald Samper, Singapore (SG); Dong-Kee Yi, Singapore (SG); Tanu Suryadi Kustandi, Sangapore (SG)

Correspondence Address: BARNES & THORNBURG, 11 SOUTH MERIDIAN, INDIANAPOLIS, IN, 46204, US

(21) Appl. No.: 11/015,116

(22) Filed: Dec. 17, 2004

(51) Int. Cl. C23F 1/00; B44C 1/22; C03C 25/68

(52) U.S. Cl. 216/41; 216/42

(57) ABSTRACT

The present invention provides a method of forming a branched structure which comprises applying colloidal-sized particles over structures. The coated structures are then etched such that the structures are etched through the colloidal particles to form branched structures. The etch may be a reactive ion etch. The structures may be microstructures formed as high aspect ratio microstructures. The colloidal-sized particles may be applied as a colloidal solution and a polyelectrolyte (PE) layer may be applied to the microstructures prior to the colloidal solution to promote adsorption of the colloidal particles.

### BACKGROUND OF THE INVENTION

The present invention relates generally to a method of fabricating a branched structure, such as a microstructure which may act as an adhesive.

Adhesives have applications ranging from day-to-day aspects of life to cutting edge technologies. Some examples of adhesives used in day-to-day aspects include tapes, fasteners and adhesive toys whilst the examples in cutting-edge technologies include manipulation of microscopic parts in micromanufacturing industries without the use of mechanical clamping, and manipulation of delicate organs such as nerves, tendons, arteries or veins, ureters and other soft tissues in the medical area. Thus, there is an ongoing need for improved adhesives.

Adhesive mechanisms in nature have been widely studied, but they have not been fully understood or exploited. One natural adhesive was uncovered from gecko's feet. The gecko not only can stick firmly to any kind of surface (dry and molecularly smooth or rough), but also can effectively release its feet with minimal effort. This adhesive mechanism is also found in Anolis lizards, some skinks and some insects. There are other remarkable abilities of gecko's feet, namely the self-cleaning mechanism of the feet and their reusability, which abilities surpass those of current adhesives. Prior studies have revealed that compliant, dry micro/nano-scale high aspect-ratio beta-keratin hairs are present on the underside of the gecko's feet and that these hairs allow the feet to adhere to any surface. This adhesion is mainly due to intermolecular forces, such as van der Waals force as well as capillary forces.

Some studies have been carried out on fabrication techniques for the microscopic hairs. For example, nanorobotic imprinting, nano-molding and electron beam lithography have been attempted as fabrication techniques. In nanorobotic imprinting, the shape of a master probe, such as an Atomic Force Microscope (AFM), an array of these probes, or some other high aspect ratio micro/nano-structure array is imprinted on a flat soft surface by indenting. The indented surface acts as a mold for silicone rubber or any other polymer. The polymer is separated from the wax template by peeling, resulting in nano-hairs. This process can be repeated autonomously to fabricate a large number of nano-hairs. In nano-molding, a membrane such as alumina with self organized high aspect ratio pores may be used as the soft surface whichacts as a mold for a liquid polymer such as polyimide or silicone rubber. Molding occurs under vacuum. After molding, the polyimide is cured and the alumnia membrane is etched away.

However, nano-molding and electron beam lithography are not suited for large scale production of synthetic adhesives as these techniques have low throughput as a result of their serial processing approach. Further, stiction problems have also been reported in nano-molding. And, indeed, no one has reported the fabrication of branched microstructures that mimic the structure of real gecko foot hairs so as to provide the rigidity to reduce stiction and the flexibility to conform to surface irregularities.

It would be highly desirable to fabricate structures that mimic the structure of real gecko foot hairs.

### SUMMARY OF THE INVENTION

The present invention provides a method of forming a branched structure which comprises applying colloidal-sized particles over structures. The coated structures are then etched such that the structures are etched through the colloidal particles to form branched structures.

The etch may be a reactive ion etch. The structures may be microstructures formed as high aspect ratio microstructures. The colloidal-sized particles may be applied as a colloidal solution and a polyelectrolyte (PE) layer may be applied to the microstructures prior to the colloidal solution to promote adsorption of the colloidal particles.

In accordance with the present invention, there is provided a method of forming a branched structure, comprising: applying a layer of colloidal-sized particles over structures; etching said structures with a medium such that said structures are etched through said particles to form branched structures.

In accordance with another aspect of the present invention, there is provided a product for use as an intermediate in forming a branched structure, comprising: a plurality of microstructures on a substrate; an adsorbed mono-layer of colloidal particles on said micro structures.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

In the figures which illustrate example embodiments of the invention,

FIGS. 1A to 1E are schematic diagrams illustrating the fabrication of branched microstructures using a photolithography technique in accordance with one embodiment of the invention;

FIGS. 2A to 2G are schematic diagrams illustrating fabrication of branched microstructures using a casting technique in accordance with another embodiment of the invention; and

FIG. 3 is a schematic view of the product of FIG. 2G, in use.

### DETAILED DESCRIPTION

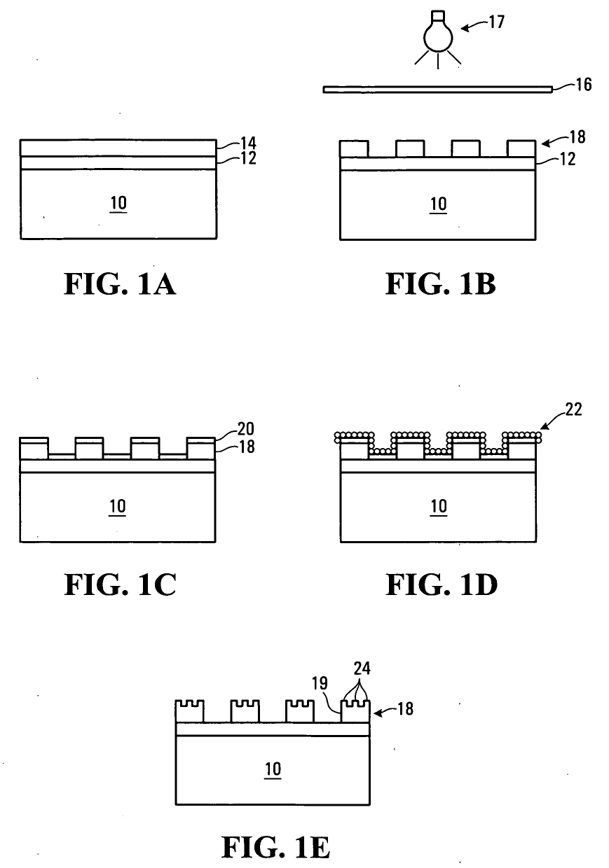

FIG. 1 illustrates the fabrication of branched microstructures using a photolithography technique in accordance with one embodiment of the invention. Turning to FIG. 1, a substrate 10 (such as a silicon wafer or borosilicate glass wafer, amongst many others) may be first cleaned to remove particulate matter on the surface and any traces of organic, ionic, and metallic impurities. After cleaning, an adhesion promotion layer 12 such as HMDS (hexaamethyldisilizane) may be deposited on the surface of the substrate 10. This step is optional and dependent on how well the chosen photoresist sticks to the substrate. A photoresist 14 is applied on the substrate 10 by spin-coating. The thickness of photoresist is dependent on how tall the overall structures are to be. Thus, to mimic the feet of the gecko the thin film may be between about 20-200 μm thick, and more typically, between about 70-100 μm thick. The photoresist may be an epoxy-based negative photoresist or any other photoresist which has the potential to provide high aspect-ratio microstructures. To remove almost all solvents from the photoresist 14, the photoresist 14 may be soft-baked. Referencing FIG. 1B, a mask 16, which may be a glass plate with a patterned emulsion of film on one side, is aligned parallel to the plane of the substrate 10 so that the pattern can be transferred onto the substrate surface. Once aligned, the photoresist 14 is exposed through the pattern on the mask 16 with a high intensity ultraviolet (UV) light 17. The photoresist 14 is then developed, followed by a post-bake to harden the photoresist 14 and to improve adhesion of the photoresist 14 on the substrate surface, thus creating microstructures 18. The dimensions of the pattern of the mask are chosen so that the width of the microstructures is small compared to their length (which equals the thickness of the photoresist layer) so as to result in high aspect ratio microstructures. The width of microstructures may range from 1 to 10 μm (similar to the diameter of gecko foot-hairs) and have a height from 20 to 200 μm to achieve an aspect ratio of 1:20. Next, with reference to FIG. 1C, a Layer-by-layer (LbL) self-assembly approach is applied to form an ionic charged layer 20 on top of the microstructures 18. The approach involves alternating exposure of the microstructures 18 to dilute aqueous solutions of polycations and polyanions. With each exposure, a polyion layer is deposited and surface ionization is reversed, allowing a subsequent layer of opposite charge to be deposited. Thus, polyelectrolyte (PE) multilayers are formed. The LbL approach is then terminated with the polycation as the topmost layer to promote the adsorption of negatively charged colloids. By using LbL, the interlayer compatibility and attractive force between the laminating electrolyte layers is increased. For this reason, multilayer deposition is preferred to deposition of a single-layer. Indeed, if only one layer is used, it does not guarantee that the one layer will stick to the surface of the film. Indeed, since the PE solution is a long chain polymer, the sticking effect of one-layer and of a multilayer is totally different. The polymer chains are entangled through neighbouring chains. Thus, not only electrostatic forces, but also physical entanglement occurs between the polyelectrolyte layers. A colloidal solution is then applied and, as seen in FIG. 1D, colloidal particles are adsorbed to form a two-dimensionally ordered monolayer 22 of colloidal particles. The colloidal particles may be negatively charged silicon dioxide particles. Other particles such as polystyrene can be used but the subsequent etch step must have sufficient selectivity between the colloids and the underlying resist to allow the colloids to serve as a mask. The colloidal particles may have a diameter of between about 0.01 to 1 μm. This colloidal layer is naturally adsorbed. After adsorption of the colloidal monolayer 22 is complete, no further adsorption occurs because the ionic charge on the topmost PE surface is reversed by the negative charge of the adsorbed colloids. With reference to FIG. 1E, the ends of the microstructures 18 were then vertically etched through the spaces between the colloids by etching, such as by reactive ion etching (RIE), resulting in nanostructures (nanopillars) 24 which project from the ends of the microstructures. Thus, the colloid particle layer acts as a mask, since the nanopillars structure is a projection of the original colloidal particle array. Thereafter, the colloidal particles may be removed.

The spacing between colloids can be tuned by adjusting the sureface charge density through the variation of the salt (NaCl) concentration of the PE solutions.

### EXAMPLE 1

A 70-100 μm thick epoxy-based negative photoresist sold under the identifier, SU-8 2050 by MicroChem. Corp., was spun on a four inch silicon p-wafer. An HMDS adhesion promotion layer was deposited by vacuum priming. The photoresist was soft baked on a hot plate at 65° C. for ten minutes and 95° C. for an hour to evaporate the solvent. A chromium (Cr) on glass mask with a patterned emulsion of film on one side was aligned with the photoresist, thus forming a coated wafer.

The coated wafer was left to cool down to room temperature and then exposed to ultra-violet radiation at 365 nm with a dose of 400 mJ/cm² for 70 seconds. A post-bake exposure was performed on the hot plate at 50° C. for ten minutes and 95° C. for 30 minutes to selectively cross-link the exposed regions of the photoresist. PGMEA as supplied by MicroChem. was used for development. The resulting microstructures were alternately immersed into a polyelectrolyte solution made of polycation such as poly(diallyyldimethylammonium chloride) (PDDA)sold by Sigma Aldrich of molecular weight 70000 and a polyelectrolyte solution made of polyanion such as poly(acrylic acid) (PAA) sold by Sigma Aldrich of molecular weight 1200. Each immersion lasted for twenty minutes and was followed by washing with deionised (DI) water, and drying under a stream of dry nitrogen gas. A monolayer of 500 nm diameter silicon dioxide colloids was formed by immersing the microstructures in an aqueous colloidal suspension (1% wt) upside down for ten minutes. The colloidal film was then washed with DI water and dried. RIE was carried out with an oxygen plasma through the silicon dioxide colloids for 20-40 minutes in a plasma etching chamber with a radio frequency of 13.56 MHz at 15 m Torr oxygen pressure, 20 sccm flow speed and 100 Watts plasma power. The silicon dioxide colloids were removed from the microstructures with hydrofluoric acid solution.

With reference to FIG. 1E, the microstructure base 19 of each of the resulting branched microstructures was 70-100 microns long and topped with a plurality of nanopillars 24 having a length of 2 to 4 μm. The microstructure base 19 had a diameter of about 5 μm and the nanopillars a diameter of about 300-400 nm The branched microstructures are capable of providing an adhesive force of about 1-10 nN.

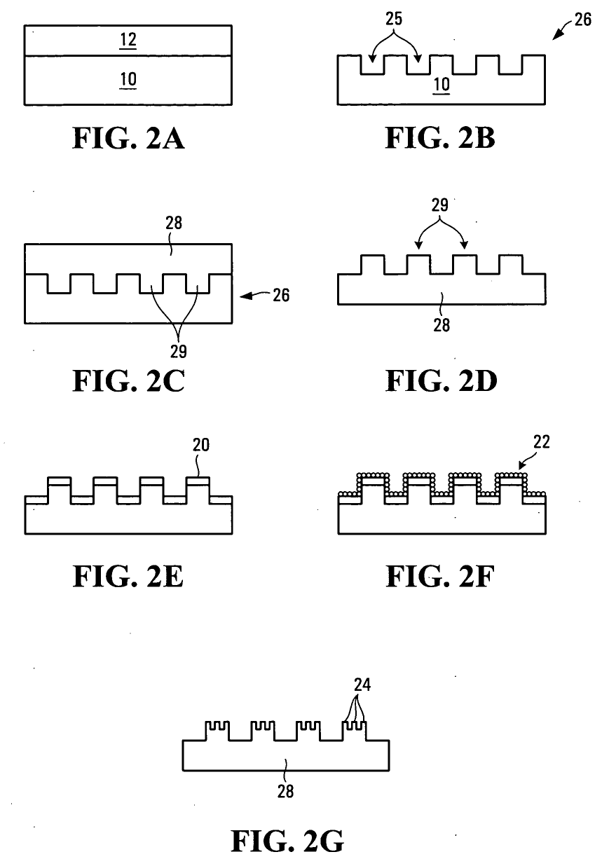

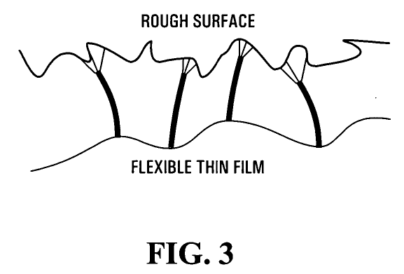

FIGS. 2A to 2G schematically illustrate fabrication of branched microstructures using a casting technique in accordance with another embodiment of the invention. Turning to FIG. 2A, a substrate 10 (such as a silicon wafer or borosilicate glass wafer, amongst many others) may be first cleaned to remove particulate matter on the surface and any traces of organic, ionic, and metallic impurities. After cleaning, a photoresist layer such as AZ4620 (Clariant Corporation) may be deposited on the surface of the silicon wafer 10 and patterned by exposing it to ultra-violet radiation. Referencing FIG. 2B, deep reactive ion etching is then applied to the substrate 10 to create trenches 25 of high aspect ratios, thus forming a mold 26. A release assisting layer such as (tridecafluoro-1,1,2,2 tetrahydrooctyl) trichlorosilane may be applied to the substrates by vacuum priming. Turning to FIG. 2C, a flexible liquid polymer 28 is poured over the mold 26 to fill the trenches 25, thus forming a thin flexible substrate 30 and high aspect ratio microstructures 29. Examples of the flexible polymer that may be used include poly-dimethyl-siloxane (PDMS), and many others. After drying, the flexible substrate 30, with microstructures 29, is then peeled off the mold 26, as indicated in FIG. 2D. Next, a Layer-by-layer (LbL) self-assembly approach is applied to form an ionic charged layer 20 on top of the microstructures 29 (see FIG. 2E). The approach involves alternating exposure of the ionic charged layer 20 to dilute aqueous solutions of polycations and polyanions. With each exposure, a polyion layer is deposited and surface ionization is reversed, allowing a subsequent layer of opposite charge to be deposited. Thus, polyelectrolyte (PE) multilayers are formed. The LbL approach is then terminated with the polycation as the topmost layer to promote the adsorption of negatively charged colloids. Colloidal particles are then deposited onto this topmost layer to form a layer 22 (as seen in FIG. 2F). After adsorption of a colloidal monolayer 22 is complete, no further adsorption occurs because the ionic charge on the topmost PE surface is reversed by the negative charge of the adsorbed colloids. Reactive ion etching (RIE) is applied vertically to the end of the microstructures 29 through the spaces between the colloids, resulting in a nanopillars 32 which project from the microstructures (as seen in FIG. 2G). The flexible substrate 30 created in this manner then lends itself to arrangements that enhance adhesion and detachment, as indicated in FIG. 3.

While two techniques have been described to create high aspect ratio microstructures, any other suitable technique may also be used, such as Lithographie, Galvanoformung und abformung (LIGA). Once the microstructures have been formed, the teachings of this invention may then be utilised to create branched microstructures.

While the described techniques were described as resulting in branched microstructures, the techniques could equally be used to form branched nanostructures.

Those skilled in the art will recognize that the adhesive branched structures of the invention may be utilized in a variety of ways. For example, the structures of the invention can be used in pick and place micromanufacturing, micromanipulation, and microsurgery applications. Other applications of the branched structures of the invention include: insect trapping, tape, robot feet or treads, gloves/pads for climbing, gripping, etc., clean room processing tools, micro-optical manipulation that does not scar a surface and leaves no residue or scratches, microbrooms, micro-vacuums, flake removal from wafers, optical location and removal of individual particles, climbing, throwing, and sticker toys, press-on fingernails, silent fasteners, a substrate to prevent adhesion on specific locations, a broom to clean disk drives, post-it notes, band aids, semiconductor transport, clothes fasteners, and the like.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method of forming a branched structure, comprising:
applying a layer of colloidal-sized particles over structures;
etching said structures with a medium such that said structures are etched through said particles to form branched structures.

2. The method of claim 1 wherein said colloidal-sized particles have a diameter of between about 0.01 to 1 μm.

3. The method of claim 1 wherein said applying comprises applying a monolayer of said particles.

4. The method of claim 3 wherein said applying comprises applying a colloid solution and further comprising forming an ionic charged top layer on said structures before said applying.

5. The method of claim 4 wherein said forming further comprises:
alternately exposing said structures to solutions of polycations and polyanions.

6. The method of claim 5 wherein said colloidal particles are negatively charged and said ionic charged top layer is a polycation layer.

7. The method of claim 3 wherein said structures are one of microstructures and nanostructures.

8. The method of claim 3 wherein said etching comprises reactive ion etching.

9. The method of claim 7 wherein said structures are formed integrally with a substrate.

10. The method of claim 9 wherein said substrate and structures are composed of a flexible polymer.

11. The method of claim 7 further comprising forming said structures by:
irradiating a photoresist through a patterned mask.

12. The method of claim 10 wherein patterns of said mask have small dimensions compared with a thickness of said photoresist so that said structures have a high aspect ratio.

13. The method of claim 12 wherein said photoresist has a thickness of between twenty and two hundred micrometers and said patterns of said mask are such that said structures have a diameter of between about one and ten micrometers.

14. The method of claim 3 further comprising forming said structures by:
deep reactive ion etching a substrate;
pouring a liquid polymer onto said substrate and allowing said polymer to dry;
peeling said polymer from said substrate.

15. A product for use as an intermediate in forming a branched structure, comprising:
a plurality of microstructures on a substrate;
an adsorbed mono-layer of colloidal particles on said microstructures.

16. The product of claim 15 further comprising alternating layers of polycations and polyanions between said substrate and said mono-layer.

17. The product of claim 16 wherein colloidal particles of said mono-layer are negatively charged and wherein a polycation layer is adjacent said mono-layer.

18. The product of claim 17 wherein said microstructures have a length of between about twenty and two hundred micrometers and a diameter of between about one and ten micrometers.

19. A method of forming a branched microstructure, comprising:
applying a mono-layer of colloidal-sized particles over microstructures;
etching said structures with a medium such that said microstructures are etched through said particles to form branched microstructures.

20. The method of claim 19 further comprising forming an ionic charged top layer on said structures before said applying.
